(19) United States
(12) Patent Application Publication
(10) Pub. No.: US 2024/0420117 A1
(43) Pub. Date: Dec. 19, 2024

(54) NON-FUNGIBLE TOKENS WITH STATIC ATTRIBUTES ON CHAIN AND DYNAMIC ATTRIBUTES OFF CHAIN

(71) Applicant: Gaxos.ai Inc., Roseland, NJ (US)

(72) Inventors: Vadim MATS, North Caldwell, NJ (US); Menachem BEN-OR, New York, NY (US)

(73) Assignee: Gaxos.ai Inc., Roseland, NJ (US)

(21) Appl. No.: 18/744,152

(22) Filed: Jun. 14, 2024

Related U.S. Application Data
(60) Provisional application No. 63/508,841, filed on Jun. 16, 2023.

(51) Int. Cl. G06Q 20/36

(52) U.S. Cl. CPC G06Q 20/3672

(57) ABSTRACT

Embodiments of the presently disclosed technology provide systems and methods for minting non-fungible token (NFT) records representing a digital asset (e.g. a digital avatar) where one or more first attributes of the NFT are stored “on-chain” and second attributes of the NFT are stored “off-chain”. Such systems and methods may comprise, for example, displaying a plurality of avatars as a plurality of display elements and, based on selecting an avatar, displaying first and second attributes. At least one second attribute is stored in an off-chain storage location based on a selection of the at least one second attribute from the displayed attributes, and an NFT avatar can be minted for the selected avatar that includes selected first attributes. The NFT avatar is stored on a blockchain network.

### CROSS-REFERENCE TO RELATED APPLICATIONS

This application claims benefit to U.S. Patent Application No. 63/508,841, filed Jun. 16, 2023, entitled “NON-FUNGIBLE TOKENS WITH STATIC ATTRIBUTES ON CHAIN AND DYNAMIC ATTRIBUTES OFF CHAIN”, which is hereby incorporated herein by reference in its entirety.

### FIELD OF THE INVENTION

The invention relates to non-fungible token (NFT) records representing a digital asset (e.g. a digital avatar) where one or more “static” attributes of the NFT (e.g. attributes used in the presentation and/or representation of an NFT) are stored as static attributes “on-chain” and dynamic attributes of the NFT are stored “off-chain” with a reference in the NFT metadata to the off-chain location.

### BACKGROUND

NFTs are cryptographic tokens (e.g., having a unique token ID) ownership of which is recorded on a blockchain. An NFT may represent various physical or digital assets or other entitlements. Often, when an NFT represents a digital asset, the digital asset is not stored on the blockchain (i.e., “off-chain”). Often, the NFT metadata points to the location of the digital asset (e.g. via a URL, URI, content identifier or other reference). Often the location of the digital asset is an external server hosting some representation of that asset. The digital asset may be in the form of a JPEG or Video file (or other media). If that URL or URI goes down the meta data points to the location but the digital asset is not accessible to the NFT owner. Other problems are known with off-chain storage of digital assets associated with NFTs.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a distributed environment for implementing NFT systems and interfaces, in accordance with the embodiments disclosed herein.

FIG. 2 illustrates further details of the NFT system of FIG. 1 according to some embodiments disclosed herein.

FIG. 3 illustrates static attributes for an example avatar in the form of a robot, in accordance with an embodiment disclosed herein.

FIG. 4 illustrates dynamic attributes for the example avatar of FIG. 3.

FIG. 5 illustrates an example user interface for minting an NFT avatar based on attributes shown in FIGS. 3 and 4, in accordance with embodiments disclosed herein.

FIG. 6 is a flowchart illustrating an example process for minting an NFT avatar, in accordance with embodiments disclosed herein.

FIG. 7 illustrates an example of reforging an NFT avatar, in accordance with embodiments disclosed herein.

FIG. 8 illustrates another example of reforging an NFT avatar, in accordance with embodiments disclosed herein.

FIG. 9 is a flowchart illustrating an example process for reforging an NFT avatar, in accordance with embodiments disclosed herein.

FIG. 10 is an example of a computing system that may be used in implementing various features of embodiments of the disclosed technology.

FIG. 11 illustrates an example data structure for storing static attributes on-chain for an NFT avatar, in accordance with embodiments disclosed herein.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

Various aspects of the invention relate to systems and methods for minting NFTs with static attributes stored on chain and dynamic attributes stored off chain. The invention may relate to NFTs that represent digital assets or other assets or entitlements. For simplicity, the disclosure will refer to the digital asset as being a digital avatar, however the invention is not so limited. The concepts and features described in connection with the digital avatar can be applied to other types of assets.

The digital avatar may have various attributes. Some attributes may be static attributes and some may be other attributes. The static attributes of the digital avatars may be, for example, attributes that are used in the presentation and representation of that asset. The static attributes may be hosted directly on the chain. These attributes will persist even if the underlying entity that minted the asset is inaccessible. Other attributes may be dynamic and may be stored off chain.

Separating the dynamic attributes, which may be stored off chain (e.g., on a centralized storage), from the static attributes stored on chain, enables at least the static attributes to be accessible and for the NFT to have value and/or utility, even if the entity that minted the NFT no longer exists and/or if the centralized storage is inaccessible. This allows the minimum functionality of the “NFT” and avatar to continue to be used even if the external dynamic attributes are unavailable.

The invention consists of leveraging a smart contract system on the block chain to store NFT records in two parts for a single NFT record. An example NFT smart contract is shown in Appendix A. Available methods for this smart contract are shown in Appendix B.

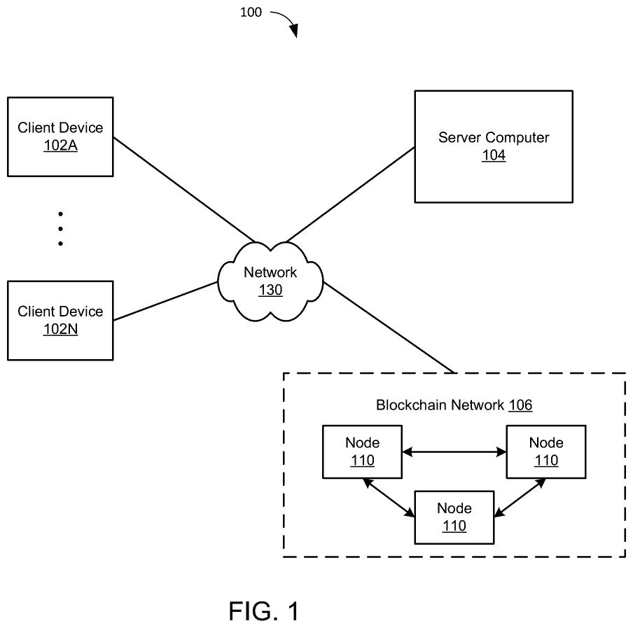

FIG. 1 illustrates an example of a NFT system 100 according to some embodiments of the disclosed technologies. Users of the NFT system 100 may employ client devices 102A-N to interact with the system 100. The system 100 may include one or more server computers and a blockchain network 106 that includes multiple nodes 110. The client devices 102, server computer 104, and blockchain network 106 may communicate over one or more networks 130.

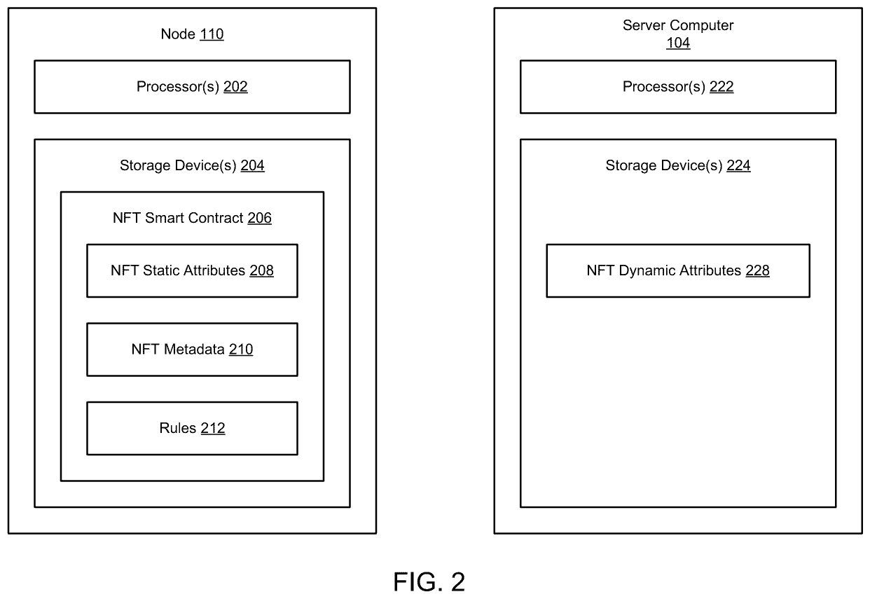

FIG. 2 illustrates further detail of the NFT system 100 according to some embodiments of the disclosed technologies. In various implementations, each node 110 may include one or more processors 202 programmed by computer program instructions stored at one or more storage devices 204. The storage device(s) 204 may store one or more NFT smart contracts 206 that execute one or more rules 230. An NFT smart contract 206 may include NFT static attributes 210 and NFT metadata 210.

The server 104 may include one or more processors 222 programmed by computer program instructions stored at one or more storage devices 224. The storage device(s) 224 may store NFT dynamic attributes 228 “off chain”. The NFT metadata 210 stored “on chain” on the blockchain node 110 may include a reference indicating the storage location of the NFT dynamic attributes 228.

### Static Attributes

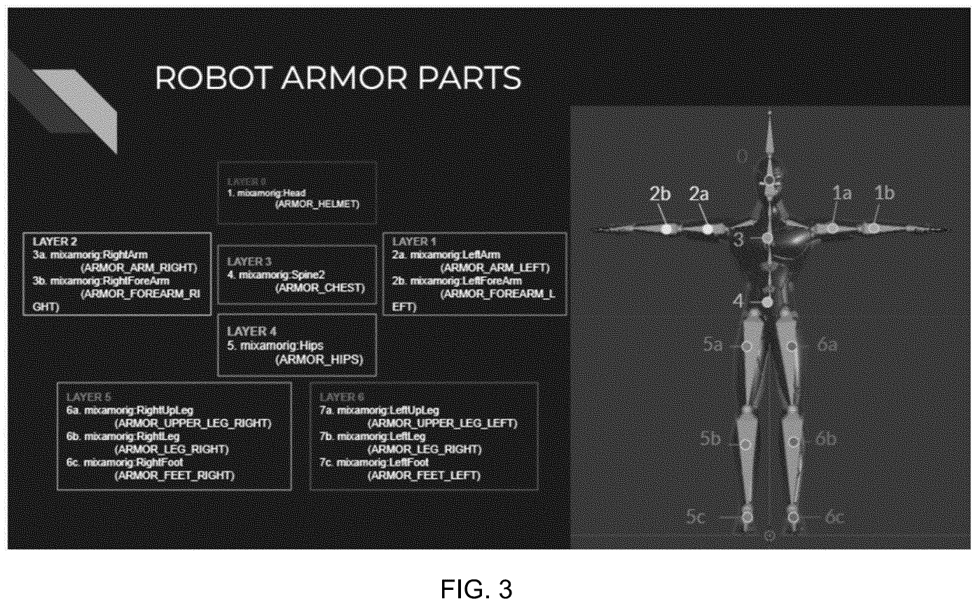

Static attributes are those attributes that represent static characteristics of the NFT. Static attributes may be stored as an on-chain record. These attributes are public and are written directly into the blockchain record that makes up the NFT avatar. FIG. 3 shows static attributes for an example avatar in the form of a robot. In this example the attributes are grouped in layers, but this grouping is not necessary in other examples.

### Dynamic Attributes

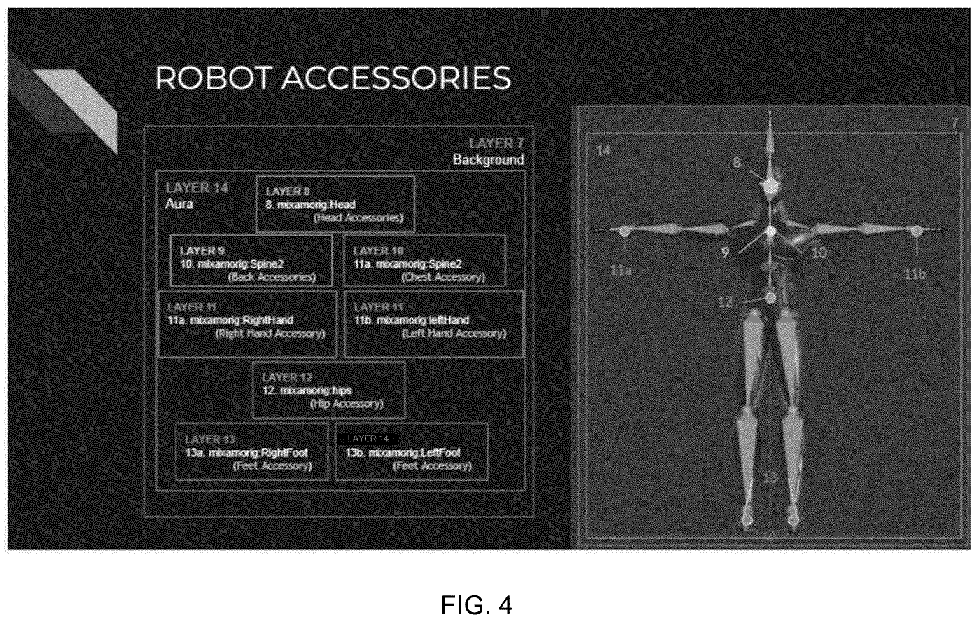

Dynamic Attributes are attributes that are stored off chain, including resources to handle the dynamic data or other content for the NFT avatar. For example, the resources for a game may include game data and systems required for running the game. Example game data may include current score for the avatar, current game level of the avatar, life level of the avatar, and similar game data. Example systems include backend systems, APIs, the games, and the infrastructure for executing the games. FIG. 4 shows dynamic attributes for the example avatar of FIG. 3. As in FIG. 3, the attributes are grouped in layers, but this grouping is not necessary in other examples.

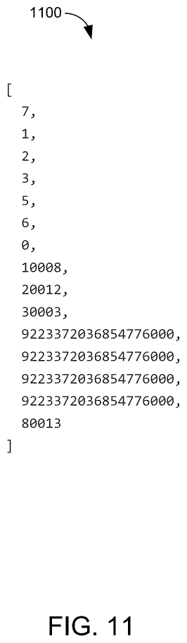

FIG. 11 illustrates an example data structure 1100 for storing static attributes on-chain for an NFT avatar. Referring to FIG. 11, the data structure 1100 includes 15 values, one for each layer, in order. Each value matches an entry in a predefined list of attributes. For example, the value “7” at the first position in the data structure 1100 array matches an entry “Layer 0/Id 7” in the predefined list. As a second example, the value “80013” in the last position matches an attribute “Kawaii”.

### Minting Behavior

Minting is the process of creating a new NFT, here an avatar. In this process, the user selects values for one or more of the static and/or dynamic attributes of the NFT. Allowable values may be predefined. In some embodiments, when a user elects to mint an avatar, the system first generates and mints a default avatar which the user can then customize. In other embodiments, the avatar is minted only after user customization.

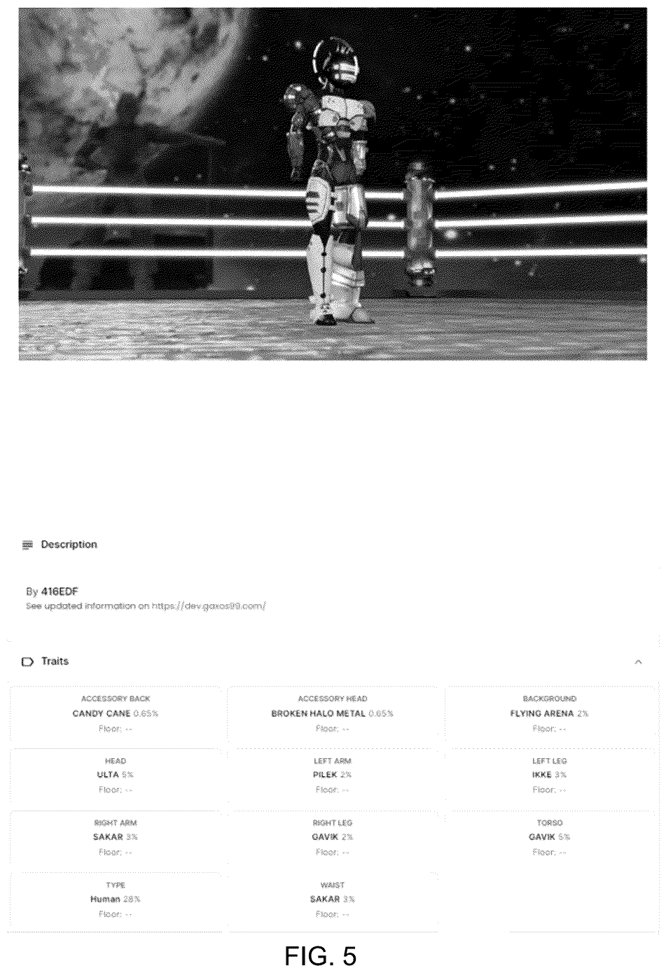

FIG. 5 shows an example user interface for minting a robot avatar NFT based on the attributes shown in FIGS. 3 and 4. The values selected by the user for the NFT attributes (also referred to as “Traits”) are shown at bottom. For example, for the “TORSO” and “LEFT LEG” attributes, the user has selected the “GAVIC” value. In this example, the user can also select the background, here “FLYING ARENA.” After selecting these values, the user may mint the NFT avatar. In this example, the minted avatar is shown in FIG. 5 at top.

Minting of NFT records is performed by the minting API and is always on. Since the static attributes that are stored on the blockchain record are recorded directly, the owner of the minted NFT knows exactly what they are receiving and that those attributes will not be different than expected. An example minting API is shown in Appendix E.

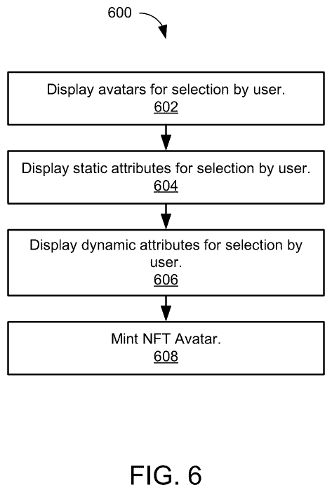

FIG. 6 is a flowchart illustrating a process 600 for minting a NFT avatar according to some embodiments of the disclosed technology. The elements of the process 600 are presented in one arrangement. However, it should be understood that one or more elements of the process may be performed in a different order, in parallel, omitted entirely, and the like. Furthermore, the process 600 may include other elements in addition to those presented. For example, the process 600 may include error-handling functions if exceptions occur, and the like.

Referring again to FIG. 6, the process 600 may include displaying avatars for selection by a user, at 602. Here the system may provide a user interface comprising display elements that include images of the avatars and controls operable by a user to select an avatar.

After the user selects an avatar, the process 600 may include displaying static attributes of the selected avatar for selection by the user, at 604. The static attributes may include a type of the avatar. In the example of FIG. 5, the type is “Human.” The static attributes may include appearance options for parts of the avatar, such as the head, legs, and arms.

Referring again to FIG. 6, the process 600 may include displaying dynamic attributes of the selected avatar for selection by the user, at 606. The dynamic attributes may include appearance options for parts of the avatar. After user selection of the static and dynamic attributes, the process may include minting the NFT avatar, at 608.

### Reforging Behavior

An owner of multiple NFTs has the ability to surrender back multiple NFTs through a reforging process and select one or more attributes from the surrendered NFTs to apply to a new “reforged” NFT. An NFT may have a static attribute labeling it as reforged or non-reforged. An example reforging smart contract is shown in Appendix C. Available methods for this smart contract are shown in Appendix D.

Reforging enables upgrading and personalizing NFTs. Various NFTs may have different attributes. Reforging enables one or more attributes from a first NFT to be selectively combined with one or more attribute(s) from one or more other NFTs. Reforging effectively enables an original NFT to be disassembled and unique attributes selectively combined into newly forged items. In some embodiments, reforging can include disassembling one or more attributes of the NFT. Certain rules for combining attributes can be imposed.

A reforged NFT can be represented as a new NFT with a new, unique token ID.

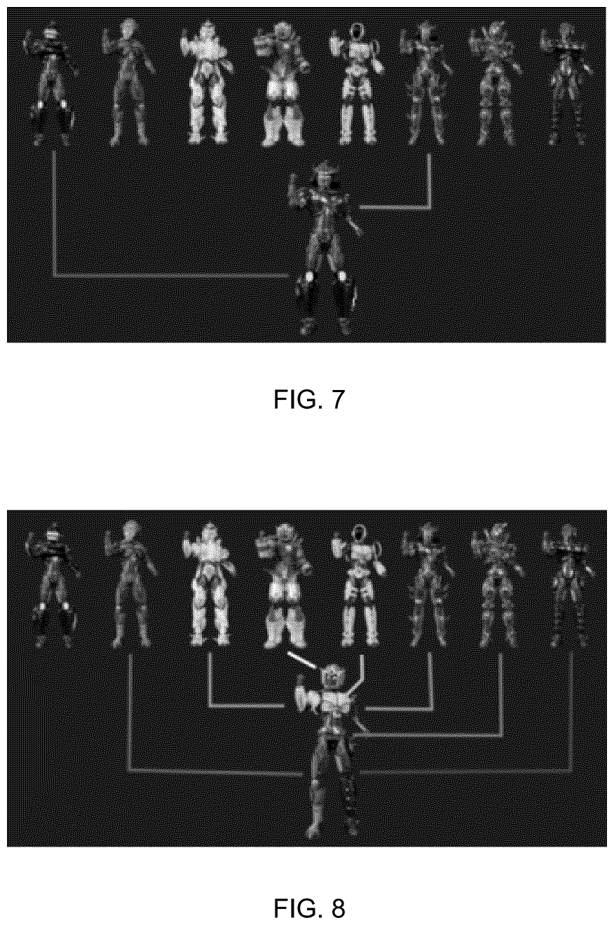

FIG. 7 illustrates an example of reforging a robot avatar. At top is shown a collection of eight avatars owned by the user. In this example, the user has surrendered two avatars in the collection to be reforged into a new, reforged avatar, shown at bottom. The attributes of the reforged avatar include attributes of both of the surrendered avatars, as shown.

FIG. 8 illustrates another example of reforging a robot avatar. At top is shown a collection of eight avatars owned by the user. In this example, the user has surrendered seven avatars in the collection to be reforged into a new, reforged avatar, shown at bottom. The attributes of the reforged avatar include attributes of both of the surrendered avatars, as shown.

Some NFTs have unique, rare or otherwise valuable attributes. In some cases combining such attributes from a combination of NFTs can create unique synergies. Historically, the ability to do this has not been feasible for many NFTs.

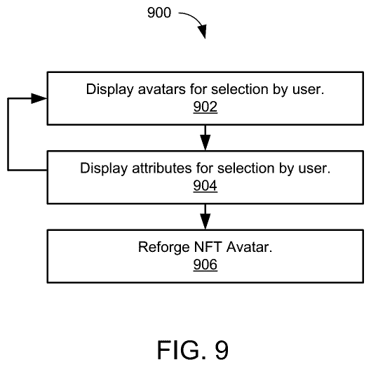

FIG. 9 is a flowchart illustrating a process 900 for reforging a NFT avatar according to some embodiments of the disclosed technology. The elements of the process 900 are presented in one arrangement. However, it should be understood that one or more elements of the process may be performed in a different order, in parallel, omitted entirely, and the like. Furthermore, the process 900 may include other elements in addition to those presented. For example, the process 900 may include error-handling functions if exceptions occur, and the like.

Referring again to FIG. 9, the process 900 may include displaying avatars for selection by a user, at 902. Here the system may provide a user interface comprising display elements that include images of avatars owned by the user and controls operable by the user to select avatars for reforging. After the user selects an avatar, the process 900 may include displaying attributes of that avatar for selection, at 904. Here the system may allow the user to choose particular static and dynamic attributes of the selected avatar to be included in the reforged avatar.

When the user has selected attributes for the first avatar, the user may select another avatar, and attributes of that avatar, repeating 902 and 904. When the user is finished, the system may reforge an avatar to include the attributes selected by the user, at 906.

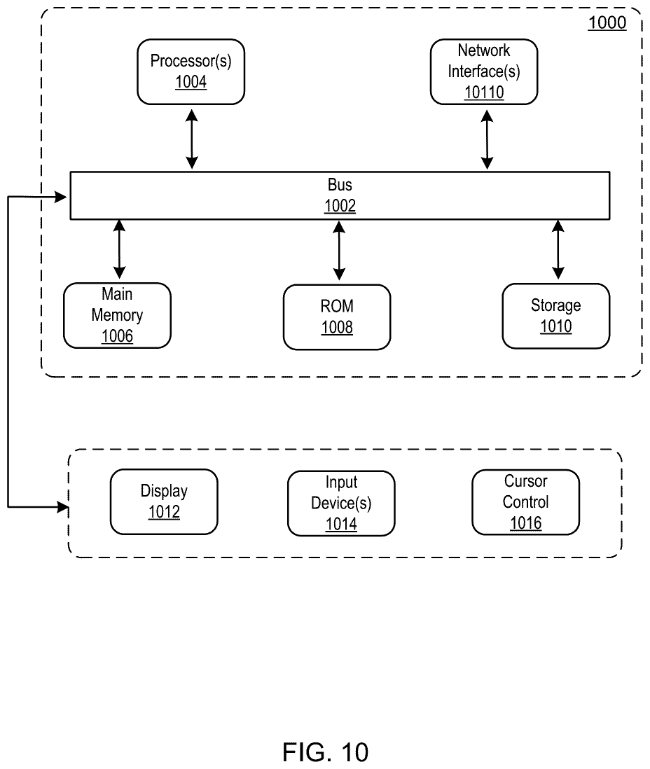

FIG. 10 depicts a block diagram of an example computer system 1000 in which embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any non-transitory media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication interface 1018 coupled to bus 1002. Network interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or a WAN component to communicate with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1018, which carry the digital data to and from computer system 1000, are example forms of transmission media.

The computer system 1000 can send messages and receive data, including program code, through the network(s), network link and communication interface 1018. In the Internet example, a server might transmit a requested code for an application program through the Internet, the ISP, the local network and the communication interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (Saas).

The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A computer-implemented method for minting non-fungible token (NFT) avatars with first attributes stored on a blockchain network and second attributes stored off the blockchain network, the method comprising:
displaying, on a user interface, a plurality of avatars as a plurality of display elements;
based on receiving inputs on the user interface selecting an avatar from the plurality of avatars:
displaying one or more first attributes on the user interface; and
displaying one or more second attributes on the user interface;
based on receiving inputs on the user interface selecting at least one second attribute, storing the at least one second attribute in a storage location off the blockchain network; and
minting an NFT avatar for the selected avatar based on receiving inputs on the user interface selecting at least one first attribute, wherein minting the NFT avatars comprises storing the selected at least one first attribute to the blockchain network to allow minimum functionality, provided by the selected at least one first attribute of the selected avatar to continue to be performed when the storage location is unavailable.

2. The computer-implemented method of claim 1, wherein the one or more first attributes comprise static attributes for presentation and representation of the selected avatar on a display.

3. The computer-implemented method of claim 1, wherein the one or more second attributes comprise dynamic attributes for resources to handle dynamic data or content for running a game using the selected avatar.

4. The computer-implemented method of claim 1, wherein storing the selected at least one first attribute to the blockchain network comprises:
storing the selected at least one first attribute in a NFT smart contract written to the blockchain network, wherein the NFT smart contract comprises NFT metadata that references the storage location of the at least one second attribute.

5. The computer-implemented method of claim 4, wherein the reference comprises one or more of: a uniform resource locator (URL), a uniform resource identifier (URI), and content identifier.

6. The computer-implemented method of claim 1, wherein the storage location is a centralized storage location separate from the blockchain network.

7. The computer-implemented method of claim 1, further comprising:
selectively combining one or more attribute from the NFT avatar with one or more attributes from a one or more other NFT avatars to generate a new reforged NFT avatar.

8. A system for minting non-fungible token (NFT) avatars with first attributes stored on a blockchain network and second attributes stored off the blockchain network, the system comprising:
one or more processors; and
a memory operatively connected to the one or more processors, and including computer code that when executed, causes the one or more processors to:
display, on a user interface, a plurality of avatars as a plurality of display elements;
based on receiving inputs on the user interface selecting an avatar from the plurality of avatars:
display one or more first attributes on the user interface; and
display one or more second attributes on the user interface;
based on receiving inputs on the user interface selecting at least one second attribute, store the at least one second attribute in a storage location off the blockchain network; and
mint an NFT avatar for the selected avatar based on receiving inputs on the user interface selecting at least one first attribute, wherein minting the NFT avatars comprises storing the selected at least one first attribute to the blockchain network to allow minimum functionality, provided by the selected at least one first attribute of the selected avatar to continue to be performed when the storage location is unavailable.

9. The system of claim 8, wherein the one or more first attributes comprise static attributes for presentation and representation of the selected avatar on a display.

10. The system of claim 8, wherein the one or more second attributes comprise dynamic attributes for resources to handle dynamic data or content for running a game using the selected avatar.

11. The system of claim 8, wherein storing the selected at least one first attribute to the blockchain network comprises:
storing the selected at least one first attribute in a NFT smart contract written to the blockchain network, wherein the NFT smart control comprises NFT metadata that references the storage location of the at least one second attribute.

12. The system of claim 11, wherein the reference comprises one or more of: a uniform resource locator (URL), a uniform resource identifier (URI), and content identifier.

13. The system of claim 8, wherein the storage location is a centralized storage location separate from the blockchain network.

14. The system of claim 8, wherein the computer code, when executed, further causes the one or more processors to:
selectively combine one or more attribute from the NFT avatar with one or more attributes from a one or more other NFT avatars to generate a new reforged NFT avatar.

15. A non-transitory computer-readable medium for minting non-fungible token (NFT) avatars with first attributes stored on a blockchain network and second attributes stored off the blockchain network, wherein the non-transitory computer-readable medium stores instructions, which when executed by one or more processing resources, cause the one or more processing resources to:
display, on a user interface, a plurality of avatars as a plurality of display elements;
based on receiving inputs on the user interface selecting an avatar from the plurality of avatars:
display one or more first attributes on the user interface; and
display one or more second attributes on the user interface;
based on receiving inputs on the user interface selecting at least one second attribute, store the at least one second attribute in a storage location off the blockchain network; and
mint an NFT avatar for the selected avatar based on receiving inputs on the user interface selecting at least one first attribute, wherein minting the NFT avatars comprises storing the selected at least one first attribute to the blockchain network to allow minimum functionality, provided by the selected at least one first attribute of the selected avatar to continue to be performed when the storage location is unavailable.

16. The non-transitory computer-readable medium of claim 15, wherein the one or more first attributes comprise static attributes for presentation and representation of the selected avatar on a display.

17. The non-transitory computer-readable medium of claim 15, wherein the one or more second attributes comprise dynamic attributes for resources to handle dynamic data or content for running a game using the selected avatar.

18. The non-transitory computer-readable medium of claim 15, wherein storing the selected at least one first attribute to the blockchain network comprises:
storing the selected at least one first attribute in a NFT smart contract written to the blockchain network, wherein the NFT smart control comprises NFT metadata that references the storage location of the at least one second attribute.

19. The non-transitory computer-readable medium of claim 15, wherein the storage location is a centralized storage location separate from the blockchain network.

20. The non-transitory computer-readable medium of claim 15, wherein the one or more processing resources are further caused to:
selectively combine one or more attribute from the NFT avatar with one or more attributes from a one or more other NFT avatars to generate a new reforged NFT avatar.
